(19) United States
(12) Patent Application Publication
(10) Pub. No.: US 2013/0132870 A1
(43) Pub. Date: May 23, 2013

(54) SYSTEM, METHOD AND COMPUTER PROGRAM PRODUCT FOR TRANSIENT STORAGE OF USER INTERFACE CONFIGURATIONS

(71) Applicants: Srinivas Vishnubhatta, San Francisco, CA (US); Guillaume Le Stum, San Francisco, CA (US); Wei Li, Foster City, CA (US)

(72) Inventors: Srinivas Vishnubhatta, San Francisco, CA (US); Guillaume Le Stum, San Francisco, CA (US); Wei Li, Foster City, CA (US)

(73) Assignee: SALESFORCE.COM, INC., San Francisco, CA (US)

(21) Appl. No.: 13/569,124

(22) Filed: Aug. 7, 2012

Related U.S. Application Data
(60) Provisional application No. 61/563,094, filed on Nov. 23, 2011.

(51) Int. Cl. G06F 3/01

(52) U.S. Cl. 715/762

(57) ABSTRACT

In accordance with embodiments, there are provided mechanisms and methods for the transient storage of user interface configurations. These mechanisms and methods for the transient storage of user interface configurations can provide accessibility of user interface configurations prior to such user interface configurations being saved by the respective author. The ability to provide accessibility of user interface configurations prior to such user interface configurations being saved by the respective author can enable the user interface configurations to be used in many different ways even before they are saved, such as enabling the re-use of a user interface configuration across multiple different user interfaces, enabling multiple different users to apply further configurations to the user interface, enabling future access to the user interface configuration, etc.

### CLAIM OF PRIORITY

This application claims the benefit of U.S. Provisional Patent Application 61/563,094 entitled “Systems and Methods for Providing a Versioned Data Model in a Distributed Environment,” by Vishnubhatta et al, filed Nov. 23, 2011 (Attorney Docket No. SFC1P1884-1798PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate gene ally to data storage, and more particularly to storage of dashboard configurations.

### BACKGROUND

The subject matter discussed in the background section should not he assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventionally, when a user interface is configured it must be saved to memory by the author before access to the configured user interface is enabled. Without being saved, the user interface configuration is only accessible while the particular author is generating the configuration. Unfortunately, the traditional technique of storing a user interface configuration only when the author selects to save the user interface configuration has traditionally exhibited various limitations. For example, in situations where the author does not save the user interface configuration and subsequently closes a window by which the user interface is being configured, the configuration of the user interface may be automatically deleted, such that the configuration may be inaccessible to the author and/or any other users. As another example, a user interface configuration is generally only capable of being re-used across multiple user interfaces once the user interface configuration has been saved. As yet another option, multiple different users are typically only capable of applying configurations to a single instance of a user interface that has already been saved,

Accordingly, it is desirable to provide techniques enabling user interface configurations to be accessible prior to an authoring selecting to save the same.

### BRIEF SUMMARY

In accordance with embodiments, there are provided mechanisms and methods for the transient storage of user interface configurations. These mechanisms and methods for the transient storage of user interface configurations can enable embodiments to provide accessibility of user interface configurations prior to such user interface configurations being saved by the respective author. The ability of embodiments to provide accessibility of user interface configurations prior to such user interface configurations being saved by the respective author can enable the user interface configurations to be used in many different ways even before they are saved, such as enabling the re-use of a user interface configuration across multiple different user interfaces, enabling multiple different users to apply further configurations to the user interface, enabling future access to the user interface configuration, etc.

In an embodiment and by way of example, a method for the transient storage of user interface configurations is provided. In use, a configuration of a user interface is received from a user. Additionally, prior to the configuration being saved by the user, a transient data set defining the configuration of the user interface is created. Further, the transient data set is stored for a predetermined period of time. Moreover, access by at least the user during the predetermined period of time to the user interface in accordance with the configuration is enabled, using the stored transient data set,

While one or more implementations and techniques are described with reference to an embodiment in which the transient storage of user interface configurations is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for the transient storage of user interface configurations in accordance with an embodiment;

FIG. 2 illustrates a method for the removal of transient data sets defining user interface configurations in accordance with an embodiment;

FIG. 3 illustrates a graphical user interface (GUI) for configuring a user interface in accordance with an embodiment;

FIG. 4 illustrates GUI having a configuration tool for configuring a user interface in accordance with an embodiment;

FIG. 5 illustrates a functional system for marking a transient data set defining a user interface configuration as non-transient in accordance with an embodiment;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for the transient storage of user interface configurations.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing the transient storage of user interface configurations will be described with reference to example embodiments.

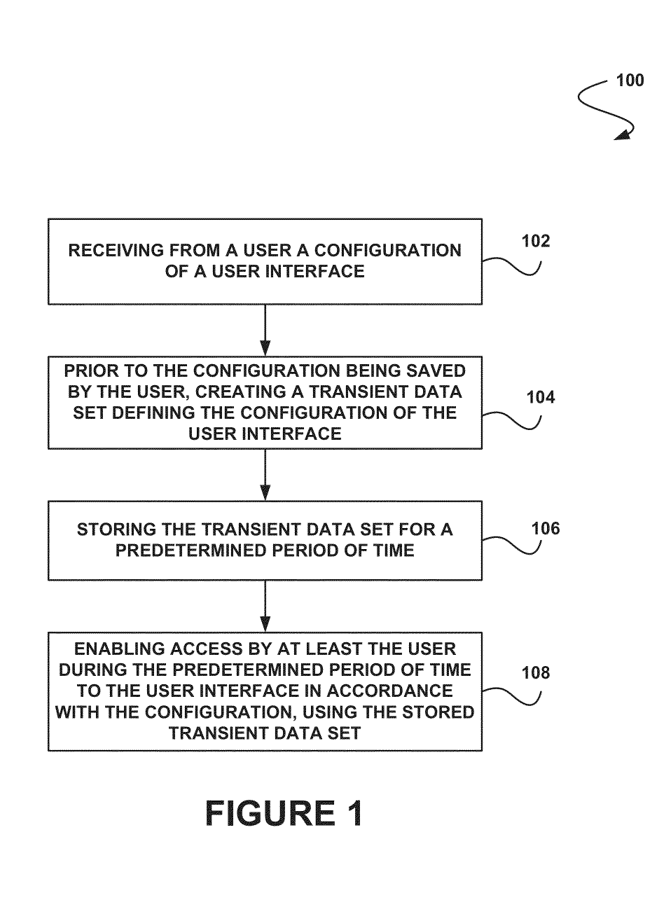

FIG. 1 illustrates a method 100 for the transient storage of user interface configurations in accordance with an embodiment. As shown in operation 102, a configuration of a user interface is received from a user. In the context of the present description, the user interface includes any interface capable of being presented to a user in accordance with a particular configuration thereof. For example, the user interface may be a graphical user interface (GUI).

In one embodiment, the user interface may be a dashboard for displaying various components. The components may be reports, data, web pages, buttons, or any other accessible user interface component. In this way, the dashboard may be a single window, etc. presenting a plurality of different components, such that the dashboard may be used for navigating to any application or other interface represented by the components displayed on the dashboard.

As noted above, a configuration of the user interface is received from the user. The configuration may be any customization of the user interface. For example, where the user interface is a dashboard the configuration may be the addition and/or deletion of components presented on the dashboard.

Optionally, the configuration of the user interface may be received using a GUI displaying a view of the user interface and allowing a drag and drop of a plurality of different predefined user interface components into the view of the user interface. In one exemplary embodiment, the GUI via which the configuration of the user interface is received may present a view of the user interface and may further present a configuration tool for use in configuring the user interface. The configuration tool may have predefined components capable of being selected and dragged and dropped onto the user interface, for configuring the user interface to include the selected component. As a further option, the configuration tool may have stylistic options to configuring a style, look, layout, etc. of the user interface and/or the components included thereon.

Additionally, prior to the configuration being saved by the user, a transient data set defining the configuration of the user interface is created. Note operation 104. In the context of the present description, the transient data set includes any data defining the configuration of the user interface which is transient in nature. For example, the transient data set may be metadata describing the configuration of the user interface, code executable to generate the user interface in accordance with the configuration, etc.

As noted above, the configuration of the user interface is data that is transient in nature. In particular, such transient nature may relate to the storage of the data set, as described in more detail below. As an option, the transient nature of the data set may be indicated by marking the data set as transient. For example, the transient data set may be a data set with an associated flag set to indicate that that data set is transient.

In one embodiment, the transient data set may be automatically created in response to (e.g. upon) receipt of the configuration of the user interface from the user. Just by way of example, each modification of the user interface (e.g. addition/removal, etc. of a component of the user interface, or stylistic change to the user interface) may automatically prompt the creation of data defining that modification. The data may be created and then optionally included in an existing transient data set defining a configuration of the user interface. Thus, creation of the transient data set may involve defining the current configuration of the user interface received from the user by updating an existing transient data set with each change to the configuration of the user interface received from the user.

Of course, it should be noted that the transient data set may be created at any time prior to the configuration of the user interface being saved by the user. In the present description, the user saving the configuration of the user interface may include an operation selected by the user to save the configuration of the user interface in memory. Accordingly, saving the configuration by the user may include the user manually selecting an option to save the configuration of the user interface.

In one embodiment, the option to save the user interface may be presented to the user for allowing the user to permanently store the configuration of the user interface in memory. Such permanent storage may specifically relate to storage of the configuration of the user interface in memory until a manual selection by the user or another user to remove the configuration of the user interface from memory. In this way, manual intervention may optionally be required for removing a saved user interface configuration from memory.

Further, as shown in operation 106, the transient data set is stored for a predetermined period of time. As described above, the transient nature of the data set may relate to the storage of the data set, namely the storage of the data set being temporary. In the present description, the transient nature of the data set may involve the transient data set only being stored for the predetermined period of time.

As an example, the transient data set may be stored for the predetermined period of time such that the transient data set may be automatically removed from memory after the predetermined period of time. This automatic removal associated with data sets that are transitory may be in opposition to the required manual removal of the data set from memory when the data set has been saved by the user and is accordingly non-transitory. As noted above, the transient data set may be stored with a flag indicating that that storage of the transient data set is transient with respect to the predetermined period of time. Further, the transient data set may be stored with a timestamp such that the timestamp may be used to determine when the predetermined period of time has elapsed, and thus when the removal should be performed.

In one embodiment, the predetermined period of time may be configured by an administrator of a system on which the transient data set is stored. Such system may be a multi-tenant on-demand database system, for example. Thus, each transient data set stored by the system may be subjected to automatic removal after storage thereof has surpassed the predetermined period of time.

Moreover, access by at least the user during the predetermined period of time to the user interface in accordance with the configuration is enabled, using the stored transient data set. Note operation 108. Namely, the user and/or other others may be allowed to access the configuration of the user interface using the transient data set, and therefore during the predetermined period of time in which the transient data set is stored.

In one embodiment, enabling access to the user interface in accordance with the configuration may include enabling additional configuration of the user interface. For example, the configuration of the user interface defined by the transient data set may be further configured. In this embodiment, the stored transient data set may be updated for defining the further configuration (e.g. as described above with respect to operation 104).

In another embodiment, enabling access to the user interface in accordance with the configuration may include enabling multiple other user interfaces to be created from user interface having the configuration. In particular, the configuration defined by the transient data set may be re-used across multiple different user interfaces. For example, the transient data set may be referenced by other user interfaces, copied to other user interfaces, etc.

In yet another embodiment, enabling access to the user interface in accordance with the configuration may include enabling the configuration of the user interface to be viewed (e.g. via the application in which the configuration was received). For example, after receiving the configuration of the user interface, the user may exit (e.g. terminate) a session with the application via which the configuration was received without the user selecting to save the configuration. After such termination, the user may then be allowed subsequent access to the configuration of the user interface via the transient data set during the predetermined period of time in which the transient data set is stored.

In still yet another embodiment, enabling access to the user interface in accordance with the configuration may include allowing at least the user to preview the user interface having the configuration. Previewing the user interface having the configuration may involve executing the use interface in accordance with the configuration such that the user interface is viewed in-use, as opposed to viewing the configuration of the user interface in the application allowing further configurations to be made to the user interface. For example, the user e.g. author) may be provided with a What You See is What You Get (WYSIWYG) interface where the user can use the stored transient data set to get a preview of the user interface (e.g. dashboard, etc.) being built (e.g. configured) before saving the configuration for the user interface.

In any case, the access by at least the user during the predetermined period of time to the user interface in accordance with the configuration may be enabled by allowing at least the user to retrieve the transient data set from storage. By creating and storing the transient data set defining the configuration of the user interface, specifically prior to the configuration being saved by the user, an instance of the definition of the configuration of the user interface may be temporarily stored as the transient data set. The transient data set may then be used for subsequent access to the configuration of the user interface during the predetermined period of time in which the transient data set is stored. This may therefore allow access to the configuration of the user interface for various purposes during the predetermined period of time in which the transient data set is stored, without the configuration actually being saved by the authoring user. Furthermore, the transient nature of the data set defining the configuration of the user interface may enable the data set, and therefore the configuration, to he automatically removed from storage after being stored for the predetermined period of time. This may enable the automatic clean-up of memory, and accordingly release of memory resources, when the configuration of the user interface may not necessarily be needed, used, etc.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

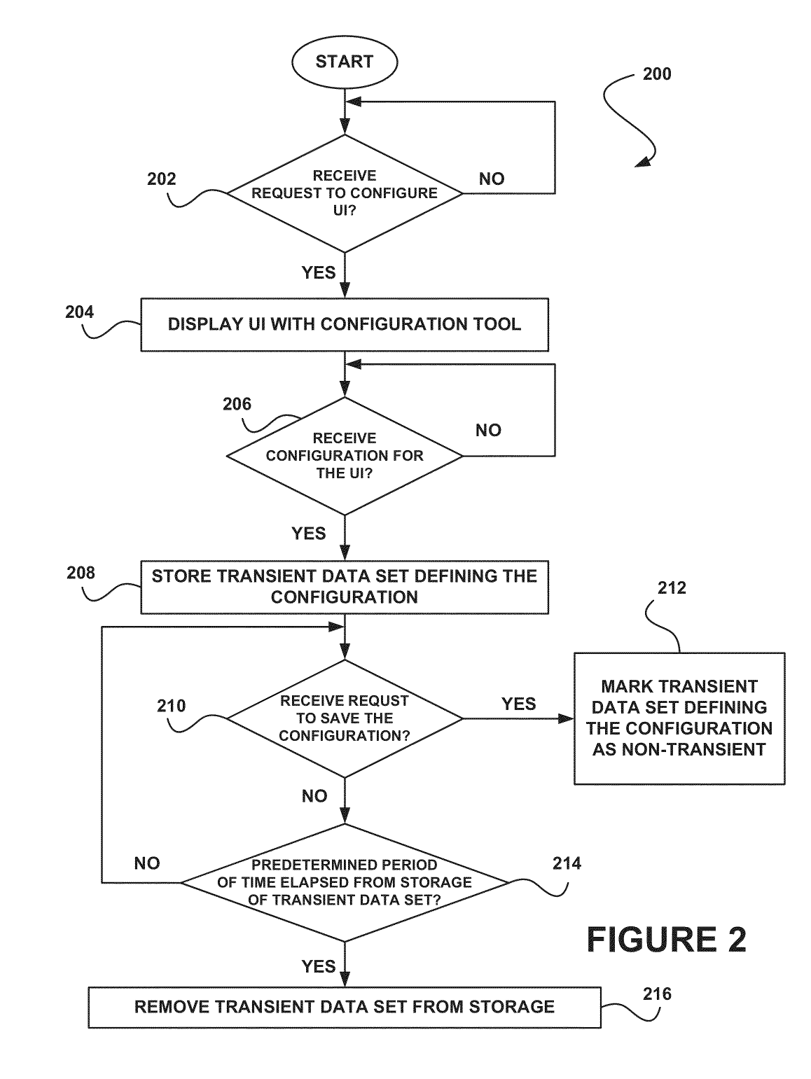

FIG. 2 illustrates a method 200 for the removal of transient data sets defining user interface configurations in accordance with an embodiment. As an option, the method 200 may be carried out in the context of the method 100 of FIG. 1. Of course, however, the method 200 may be carried out in any desired environment. It should also be noted that the aforementioned definitions may apply during the present description.

As shown in decision 202, it is determined whether a request to configure a user interface has been received. The request may be received by a user initiating an application capable of being utilized to configure a user interface, in one embodiment. As another option, the request may be received by opening a previously saved definition of the user interface in the application. If it is determined that a request to configure a user interface has not been received, the method 200 continues to wait for such a request.

However, once it is determined that a request to configure a user interface has been received, the user interface is displayed with a configuration tool. Note operation 204. For example, the user interface may be displayed in the application capable of being utilized to configure the user interface, where such application includes the configuration tool (e.g. with predefined components, styles, etc. capable of being selected for configuring the user interface). In one embodiment, the user interface may be displayed as a blank interface. In another embodiment, the user interface may be displayed with a previously received configuration to the user interface.

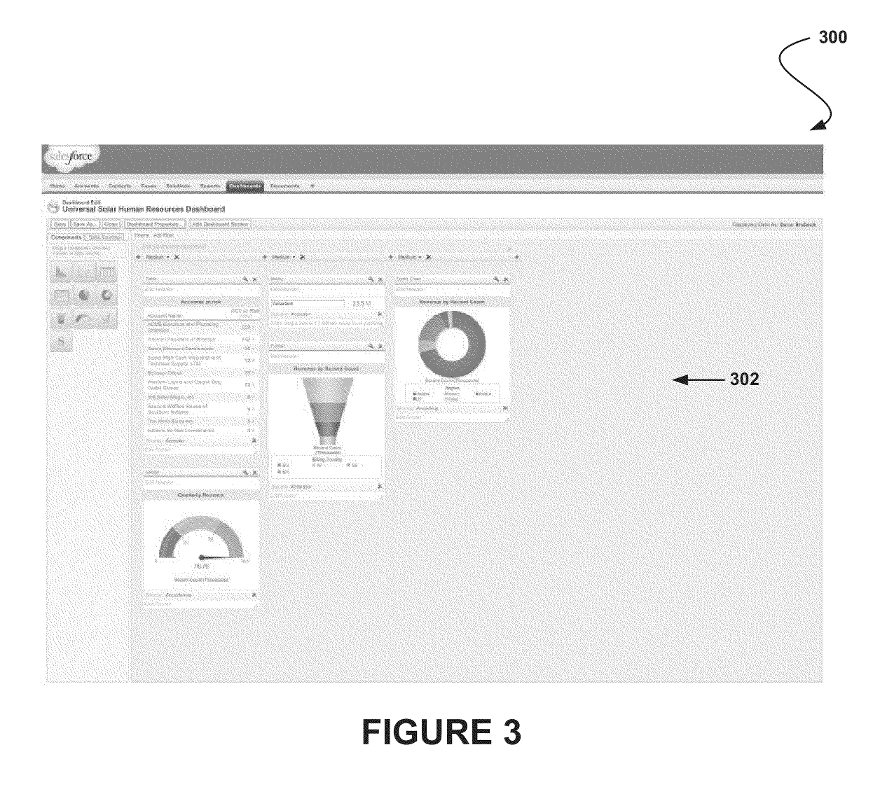

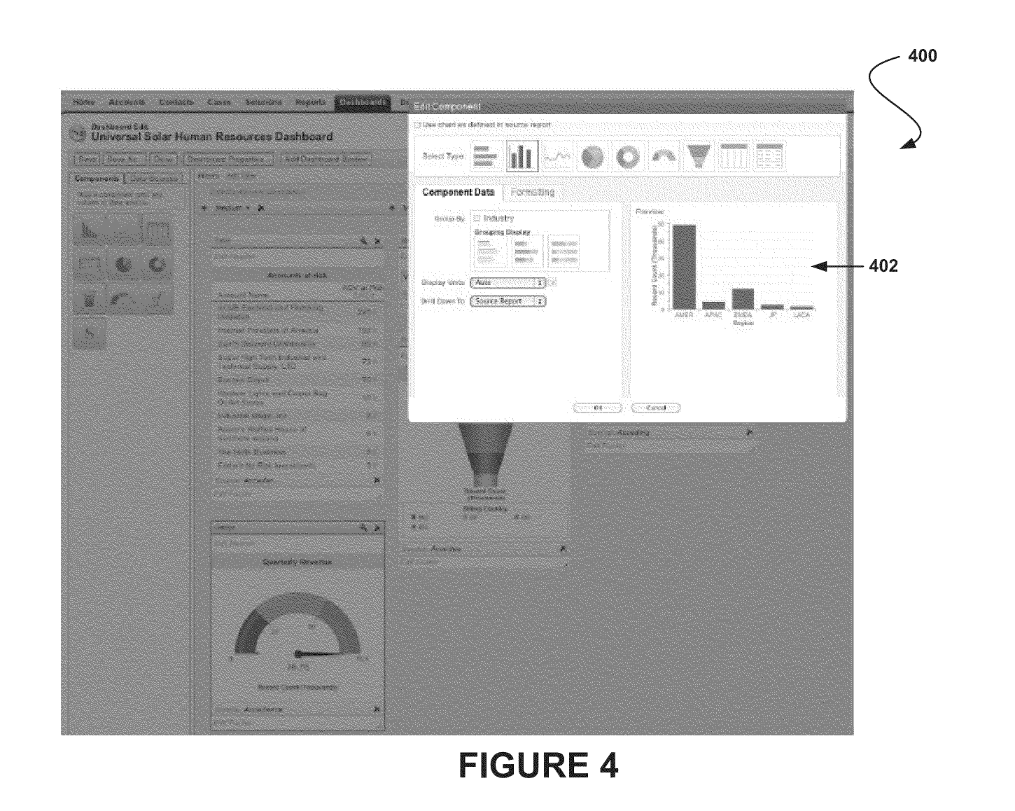

FIG. 3 illustrates an example of a GUI 300 of the aforementioned application capable of being used for configuring the user interface in accordance with an embodiment. Such GUI 300 displays a configuration of a user interface 302 in which various components have been added to the user interface. FIG. 4 illustrates an example of a 400 of the aforementioned application having a configuration tool 402 for configuring a user interface in accordance with an embodiment. Such configuration tool 402 allows a selected component added to the user interface to be further configured (e.g. with particular data, styles, etc.).

Further, it is determined in decision 206 whether a configuration for the user interface is received. For example, it may be determined whether the configuration tool has been used to create a configuration of the user interface. As another example, it may be determined whether any of the predefined components, styles, etc. provided by the configuration tool have been selected for configuring the user interface.

If it is determined that a configuration for the user interface has not been received, the method 200 continues to wait for such a configuration. However, in response to receipt of a configuration of the user interface, a transient data set defining the configuration is stored. Note operation 208. Thus, the transient data set defining the configuration may be created in response to the receipt of the configuration, for storage thereof. Optionally, the transient data set may be stored as a data set defining the configuration, along with a flag set to indicate that the data set is transient and a timestamp representing the storage of the data set.

It is then determined in decision 210 whether a request to save the configuration has been received. In the present embodiment, the request to save the configuration is a request received from a user via manual input from the user. It should be noted that such determination may be only be prompted as a result of a user selecting an option to save the configuration, such that the determination may not necessarily be proactive but instead reactive to the user's input.

If it is determined that a request to save the configuration has been received, the transient data set defining the configuration is marked as non-transient, as shown in operation 212. For example, the flag set to indicate that the data set is transient may be removed from being stored in association with the data set defining the configuration. Accordingly, the transient data set may be converted to a non-transient data set, such that the data set may be stored permanently until a request to remove the data set from memory is received by a user.

If it is determined that a request to save the configuration has not been received, it is further determined in decision 214 whether a predetermined period of time has elapsed from the storage of the transient data set. For example, the timestamp stored in association with the data set marked as transient may be compared to a current time to determine whether more than the predetermined period of time has elapsed between the timestamp and the current time. Of course, other embodiments are considered where the predetermined period of time relates to a scheduled clean-up operation, in which it is simply determined whether the data set is marked as transient at the time of the scheduled clean-up operation.

If it is determined that the predetermined period of time has not elapsed from the storage of the transient data set, the method 200 again waits for a request to save the configuration (decision 210) or for the predetermined period of time to have elapsed from the storage of the transient data set (decision 214). On the other hand, in response to a determination that predetermined period of time has elapsed from the storage of the transient data set, the transient data set is removed from storage, as shown in operation 216. Accordingly, if the data set is marked as transient, such data set is automatically removed from memory after having been stored for the predetermined period of time.

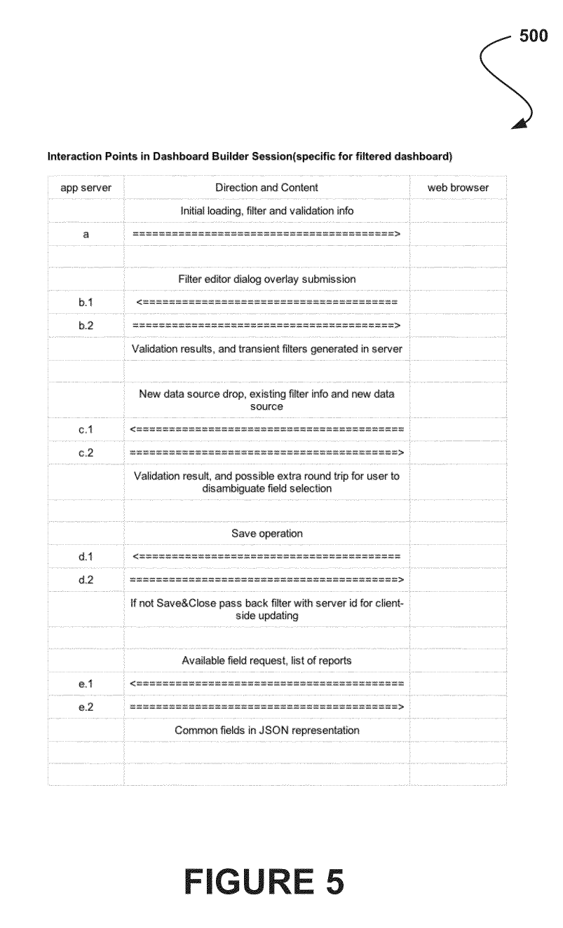

FIG. 5 illustrates a functional system 500 for marking a transient data set defining a user interface configuration as non-transient in accordance with an embodiment. As an option, the system 500 may be implemented in the context of FIGS. 1-4. Of course, however, the system 500 may be implemented in any desired environment. Yet again, it should be noted that the aforementioned definitions may apply during the present description.

As shown, the functional system 500 includes an application server and a web browser. In one embodiment, the web browser may be located on a user computer. In another embodiment, the application server may be a server of a multi-tenant on-demand database system. The web browser and the application server may optionally be in communication via a network (e.g. the Internet, etc.).

Upon a connection between the web browser and the application server, in which the web browser requests to configure a user interface, the application server in operation (a) performs initial loading of an application capable of being utilized for configuring a user interface, along with filter and validation information associated with the user interface. The filter information may relate to a previously received configuration of the user interface. The previously received configuration of the user interface may be stored by the application server as a transient data set or a non-transient data set. The validation information may relate to validation of the previously received configuration of the user interface.

The application loaded in the web browser is then used by a user to configure a portion of the user interface to include a particular component, shown as a filter editor dialog overlay submission in operation (b.1). In response to the configuration in (b.1), the configuration is validated by the application server and a transient data set defining the configuration is created by the application server, as shown in operation (b.2). Further, the application loaded in the web browser is then used by a user to configure a new data source for the component (e.g. data to be processed and output by the component), as shown in operation (c.1). In response to the configuration in (c.1), the configuration is validated by the application server and a transient data set defining the configuration is created by the application server, as shown in operation (c.2).

Further, the user then selects a save operation with respect to the configuration, as shown in operation (d.1). In operation (d.2) application server, in response to the save operation, converts the transient data set to a non-transient data set, such that the data set is stored as non-transient data. Further, if the user selected a save and close operation in which the configuration is saved and then the application is terminated, the application is closed. If the user only selected a save operation, such that the application is not terminated thereafter, an identification of the non-transient data set is sent to the client computer with an identifier of the server on which the non-transient data set has been stored. Thus, the client computer has a reference to the non-transient data set.

The user then uses the web browser to preview the user interface having the configuration, which is received by the application server in the form of an available field request and list of reports to be included in the user interface, as shown in operation (e.1). The application server returns data to the web browser in accordance with the configuration of the user interface, as shown in operation (e.2).

### Exemplary Embodiment

When building a dashboard, a user may wish to see changes as they take effect, i.e., in real-time or near real-time. For example, a user may wish to preview a dashboard using transient data prior to saving the dashboard. However, the user may not want to keep the transient data used in the preview. Moreover, the user may not want any performance degradation during a preview. The following is directed to one or more embodiments for implementing these features.

In an embodiment, to differentiate a transient filter from a saved filter, a “transient” flag may be added to filter related metadata at the schema level. When users are editing a filter for a dashboard, before they save the dashboard, filters may be stored to database table but marked as transient. The same applies to those filter items as being created by users but not finally saved. When users proceed to save the dashboard, the application server clears the transient flag associated with those saved filters and filter items. Doing so makes use of the dashboard component refreshing run time for both transient filters and saved filters. Also, when multiple users are working on the same dashboard, the save action from one user may not impact other users since transient filters are only periodically cleaned.

In an embodiment, a schema may include two main database tables for storing filter related metadata: dashboard_filter and dashboard_filter_item. The dashboard_filter table may be used to store the entity field a filter is built upon, and the dashboard_filter_item table may be used to store the filter conditions user created. In an embodiment, each table has one column to store the transient information.

As described above, the data associated with the transient filters be cleaned-up. In an embodiment, the data consists of both metadata defining the transient filters and chart data. In the application server, there may already exist one task for cleaning up transient chart data generated during dashboard builder sessions. In an embodiment, the filtered dashboard cleanup task may be encoded for inclusion in the queue.

In an embodiment, the process for cleanup may include: (1) getting entries of organization, dashboard, user, report, etc. from all rows in dashboard component update table which are marked as transient and more than certain days old; (2) marking the selected rows as “non-transient” to avoid duplicated checking later; removing those entries belong to valid dashboard components by checking against dashboard and dashboard component table; and, for the remaining entries, cleaning up the corresponding rows in chart data table as well dashboard component update tracking table.

The entries extracted in step 1 above may require expansion in order to couple the process with chart data cleanup. Step 3 may require joining with the dashboard_filter_item table to make sure the right entries are cleaned. Transient dashboard_filter metadata may also require cleaning. In an embodiment, there may be a task for specifically cleaning up filtered related transient data, including: (1) getting all transient dashboard filters based on a configurable expiration policy; (2) extracting the filters that are not associated with any filter items by joining to dashboard filter item table and clean those entries; (3) getting all transient dashboard filter items based on a configurable expiration policy; (4) for each expired filter item, extracting rows from dashboard component update tracking tables containing the filter item; (4a) if there is no dashboard component update entry for this filter item, putting the filter item aside for bulk deletion in 5; (4b) if there are some dashboard component update entries with this filter item, putting those dashboard component update entries aside for bulk deletion in 5; and (5) bulk deleting filter item collected in step (4a), bulk delete dashboard component update table collected in step ii as well as their corresponding rows from chart data table.

An embodiment contemplates performance impact. A first instance of performance impact is the extra server trips incurred while editing a filtered dashboard. To minimize this impact, network payload may be reduced. Another potential performance impact is the size of chart data table. This may be controlled by periodically cleaning up the entries associated with the transient filters.

### System Overview

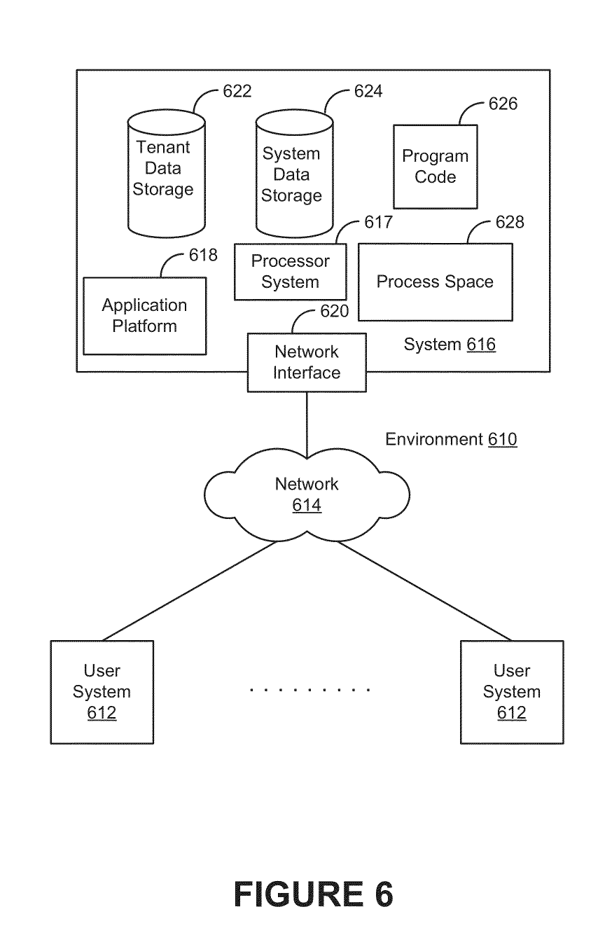

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

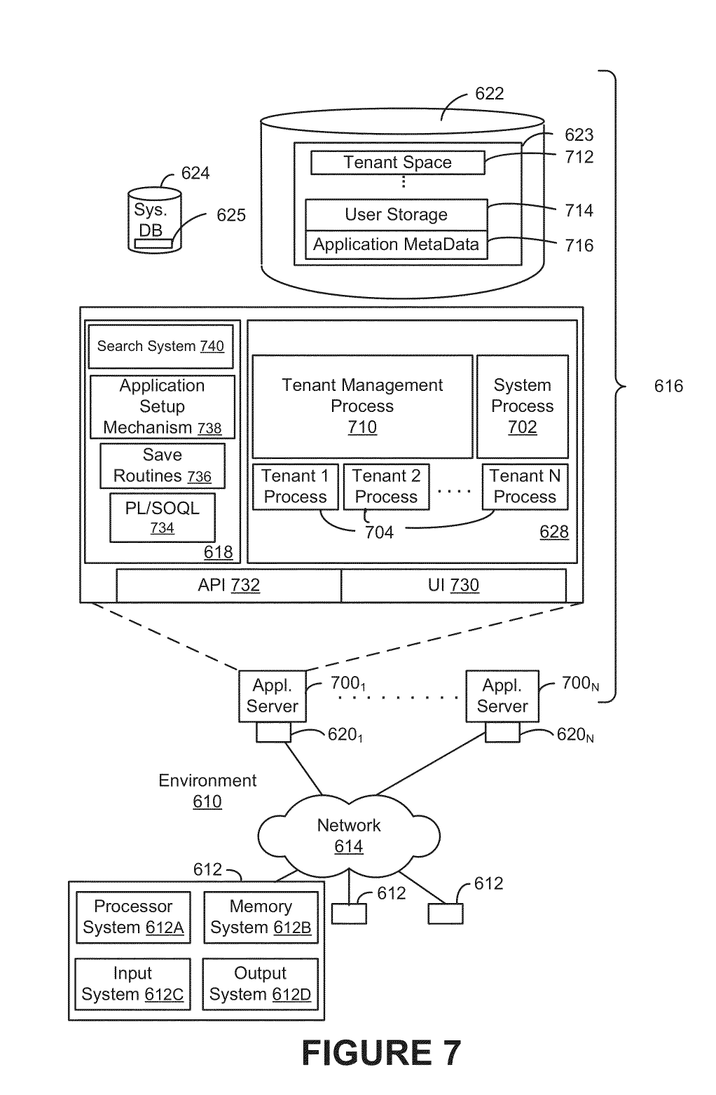

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 516 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
receiving a configuration of a user interface from a user;
prior to the configuration being saved by the user, creating a transient data set defining the configuration of the user interface;
storing the transient data set for a predetermined period of time; and
enabling access by at least the user during the predetermined period of time to the user interface in accordance with the configuration, using the stored transient data set.

2. The computer program product of claim 1, wherein the user interface is a dashboard.

3. The computer program product of claim 1, wherein the configuration of the user interface is received using a graphical user interface displaying a view of the user interface and allowing a drag and drop of a plurality of different predefined user interface components into the view of the user interface.

4. The computer program product of claim 1, wherein saving the configuration by the user includes the user manually selecting an option to save the configuration of the user interface.

5. The computer program product of claim 1, wherein the transient data set is automatically created in response to receipt of the configuration of the user interface.

6. The computer program product of claim 1, wherein the predetermined period of time is configured by an administrator of a system on which the transient data set is stored.

7. The computer program product of claim 6, wherein the system includes a multi-tenant on-demand database system.

8. The computer program product of claim 1, wherein the transient data set is stored with a flag indicating that that storage of the transient data set is transient with respect to the predetermined period of time.

9. The computer program product of claim 1, wherein enabling access to the user interface in accordance with the configuration includes enabling additional configuration of the user interface.

10. The computer program product of claim 1, wherein access to the user interface in accordance with the configuration is enabled for the user and at least one other user, using the stored transient data set.

11. The computer program product of claim 1, wherein enabling access to the user interface in accordance with the configuration includes enabling multiple other user interfaces to be created from user interface having the configuration.

12. The computer program product of claim 1, further comprising receiving a request to save the configuration of the user interface from the user.

13. The computer program product of claim 12, further comprising marking the transient data set as non-transient to convert the transient data set to a non-transient data set, in response to the receipt of the request to save the configuration of the user interface.

14. The computer program product of claim 1, further comprising determining that the transient data set is marked as transient and that the predetermined period of time has elapsed from the storage of the transient data set.

15. The computer program product of claim 14, further comprising removing the transient data set from storage in response to the determination that the transient data set is marked as transient and that the predetermined period of time has elapsed from the storage of the transient data set.

16. The computer program product of claim 1, further comprising terminating a session with an application used for receiving the configuration of the user interface from the user, wherein access by at least the user during the predetermined period of time to the user interface in accordance with the configuration is enabled after the termination of the session with the application.

17. The computer program product of claim 1, wherein the access by at least the user during the predetermined period of time to the user interface in accordance with the configuration is enabled by allowing at least the user to retrieve the transient data set from storage.

18. The computer program product of claim 1, wherein enabling access by at least the user during the predetermined period of time to the user interface in accordance with the configuration includes allowing at least the user to preview the user interface having the configuration.

19. A method, comprising:
receiving a configuration of a user interface from a user;
prior to the configuration being saved by the user, creating a transient data set defining the configuration of the user interface, utilizing a processor;
storing the transient data set for a predetermined period of time; and
enabling access by at least the user during the predetermined period of time to the user interface in accordance with the configuration, using the stored transient data set.

20. An apparatus, comprising:
a processor for:
receiving a configuration of a user interface from a user;
prior to the configuration being saved by the user, creating a transient data set defining the configuration of the user interface;
storing the transient data set for a predetermined period of time; and
enabling access by at least the user during the predetermined period of time to the user interface in accordance with the configuration, using the stored transient data set.

21. A method for transmitting code, comprising;
transmitting code for receiving a configuration of a user interface from a user;
transmitting code for creating a transient data set defining the configuration of the user interface, utilizing a processor, prior to the configuration being saved by the user;
transmitting code for storing the transient data set for a predetermined period of time; and
transmitting code for enabling access by at least the user during the predetermined period of time to the user interface in accordance with the configuration, using the stored transient data set.
